(19) United States
(12) Patent Application Publication
(10) Pub. No.: US 2005/0141752 A1
(43) Pub. Date: Jun. 30, 2005

(54) Dynamically modifiable keyboard-style interface

(75) Inventors: Stephen Dana Bjorgan, San Francisco, CA (US); Alfred Chioiu, San Jose, CA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, S.A., Paris (FR)

(21) Appl. No.: 10/748,146

(22) Filed: Dec. 31, 2003

(51) Int. Cl. G06K 9/00; G06K 9/20; G03B 21/26

(52) U.S. Cl. 382/103; 382/107; 382/312; 353/28; 353/30

(57) ABSTRACT

A method and system for providing a configurable user-input device in the form of a keyboard input device. In one embodiment, a projection unit projects a dynamically configurable keyboard pattern onto a planar or non-planar surface. Interactions with that pattern are monitored by at least one motion sensor to identify how a user is using the pattern.

### BACKGROUND OF THE INVENTION

1. Field of the Invention

The present invention is directed to a dynamically modifiable keyboard-style interface, and, in one embodiment, to a laser drawn keyboard interface that dynamically changes according to user preferences or commands.

2. Discussion of the Background

Keyboards for personal computers, such as is shown in FIG. 1, are known user-input devices. Known keyboards have included numerous keys, including a “standard” style keyboard utilizing approximately 101 keys. However, new design for keyboards have emerged that have required that an existing keyboard be thrown out and replaced by the new design since the physical arrangement of keys were such that new keys could not simply be added to an existing keyboard.

Keyboards are also not the only user input device that a user often interacts with. In the laptop environment, such as is shown in FIG. 2, a user also has access to a touch pad that sits between the user and the keyboard keys. Such a positioning of the mouse pad is preferable for manipulation of the mouse pad, but the mouse pad is often accidentally touched while typing. This causes the computer to erroneously believe that the user intended to signal a click or movement of the mouse. The positioning of the mouse pad also increases the distance that a user has to reach to get to the keys, and increases the required depth of the computer in order to fit both the mouse pad and keys.

Keyboards are also often bulky and sometimes require wires to connect the keyboard to the computer. Such requirements cause many users to wish to not carry a keyboard. Keyboards, however, are a more rapid input device than a PDA touch screen or character recognition solutions. Accordingly, many people would often like to have a keyboard without the hassle and bulk of carrying a keyboard. A known concept for a virtual keyboard, for computers and PDAs, has been presented by Canesta. The system includes a pattern projector that is believed to be fixed, an IR light source (behind an engraved film) and an IR sensor module. However, a problem associated with the design of the Canesta system is that, by virtue of the film used, the pattern drawn by the pattern projector and analyzed by the sensor module appears to be fixed and does not allow for dynamic reconfiguration of the drawn pattern and interactions with the pattern.

Keyboards are also poor input devices in a multi-language environment. For example, in a kiosk in an international airport, it is difficult to have only one keyboard since keyboards are actually language dependent. For example, while the US-style keypad uses a “QWERTY” layout, France uses a “AZERTY” lay-out. Also, alternative keyboard interfaces (such as Dvorak style keyboards) exist, and users accustomed to those alternative interfaces may have difficulty in using a “Standard” keyboard.

Some provisions exist to cause a computer to pretend that an existing keyboard with letters and symbols printed on it in one fashion is actually a keyboard corresponding to an alternate language. However, in such an environment, the user does not actually see the letters as they would appear on the alternate keyboard, and the user can become confused.

### SUMMARY OF THE INVENTION

The present invention is directed to a virtual user-input device that enables various input configurations to be utilized dynamically such that at least one of the keyboard layout and keyboard character mappings are changed dynamically.

One embodiment of a system for achieving such a keyboard includes a dynamic pattern generation module and a motion sensor for determining interactions with the pattern(s) generated by the dynamic pattern generation module. The dynamic pattern generation module may be either a projector-based image or a monitor-based image.

### BRIEF DESCRIPTION OF THE DRAWINGS

These and other advantages of the invention will become more apparent and more readily appreciated from the following detailed description of the exemplary embodiments of the invention taken in conjunction with the accompanying drawings, where:

FIG. 1 is a schematic illustration of a known, fixed-key keyboard for a desktop-style personal computer;

FIG. 2 is a schematic illustration of a known laptop-configuration with a set of fixed keyboard keys and a touchpad area with corresponding mouse buttons;

FIG. 3 is a schematic illustration of a laptop including a keyboard implemented by a dynamic pattern generation module and a motion sensor according to the present invention;

FIG. 4 is a schematic illustration of a laptop including a keyboard and mousepad implemented by a dynamic pattern generation module and a motion sensor according to the present invention;

FIG. 5 is a schematic illustration of an embodiment of a dynamic user interface based on a projection unit operating remotely from an application server from which the dynamic user interface is delivered over a wired network;

FIG. 6 is a schematic illustration of an embodiment of a dynamic user interface using a monitor-based image and operating remotely from an application server from which the dynamic user interface is delivered over a wired network;

FIG. 7 is a schematic illustration of an embodiment of a dynamic user interface based on a projection unit operating remotely from an application server from which the dynamic user interface is delivered over at least one wireless network; and

FIG. 8 is a schematic illustration of an embodiment of a dynamic user interface using a monitor-based image and operating remotely from an application server from which the dynamic user interface is delivered over at least one wireless network.

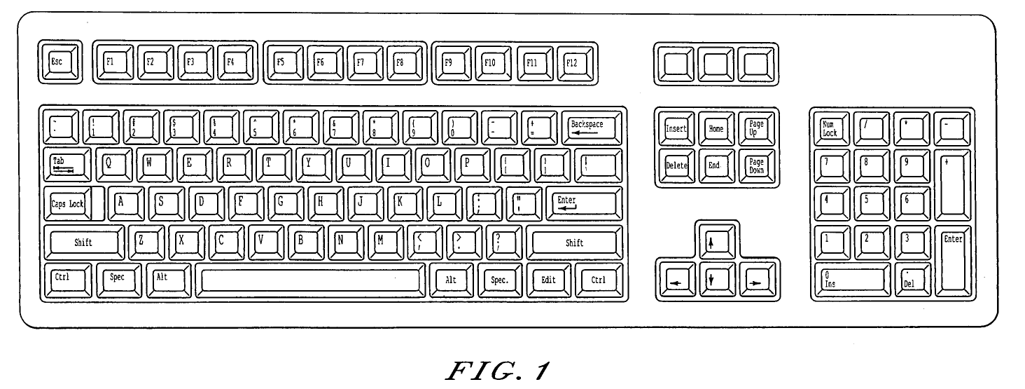

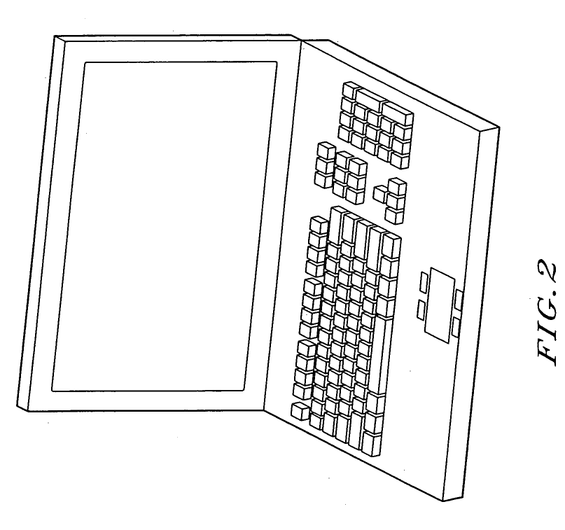

### DETAILED DESCRIPTION OF THE PREFERRED EMBODIMENTS

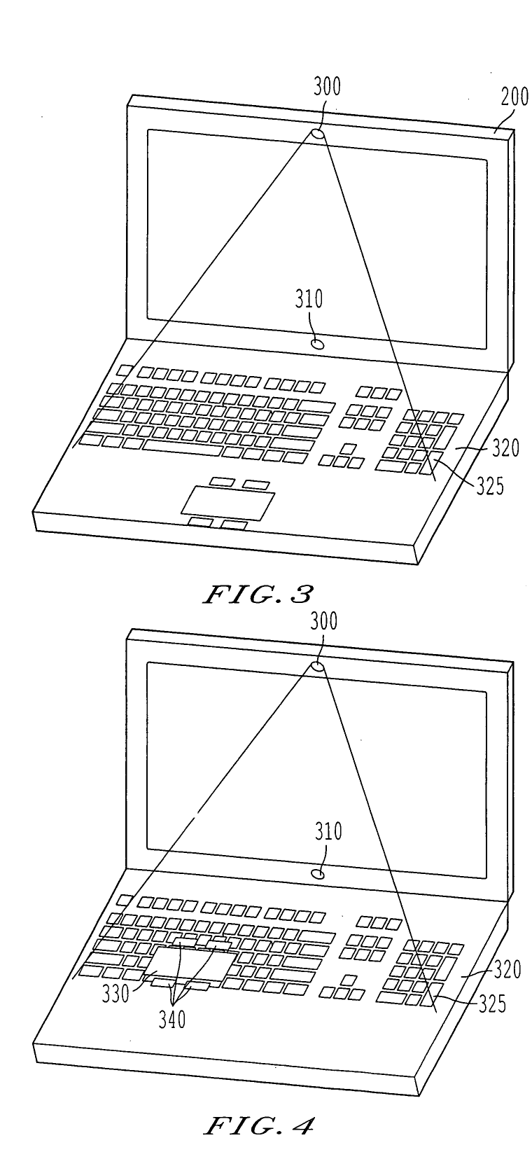

According to an embodiment of a dynamic user interface according to the present invention, FIG. 3 illustrates a laptop computer 200 including (1) a projection unit 300 at the top of the flip-top of the laptop computer 200 and (2) a motion sensor 310 at the base of flip-top of the laptop computer 200. The projection unit 300 may be a laser-based projection system and may include possibly at least one mirror. Potential laser-based displays include the laser-based display described in the article entitled “Cell phone captures and projects images” in Laser Focus World, July 2003. An alternate embodiment utilizes the Laser Projection Display from Symbol Technologies as is described in Symbol Technologies article “Preliminary Concept: Laser Projection Display (LPD).” The contents of both of those articles is incorporated herein by reference. However, the projection unit 300 is designed to display more than one pattern onto the base unit 320. The projection unit 300 may project a keyboard-style image 325 on either a planar surface or a 3D surface. The motion sensor 310 may include an IR beam transmitter and an IR sensor which may belong to either separate components or a single integrated component. Other technologies for motion sensing may also be used instead of IR transceivers.

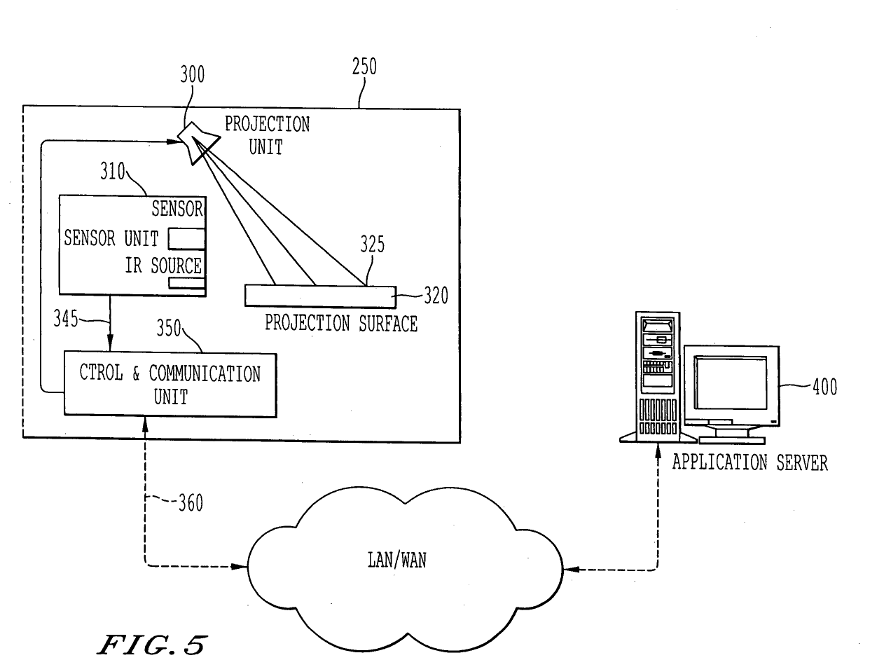

As shown in the example of FIGS. 3 and 4, a keyboard-style pattern 325 is projected onto the base unit 320. As would be understood by those skilled in the art, the base unit 320 may include registration marks thereon in order to indicate to a user when the projection unit 300 is aligned with the motion sensor 310. Moreover, the laptop computer 200 may provide a calibration process or method by which points on the projected keyboard-style image 325 are identified to the motion sensor 310. This calibration process enables the image to be projected by the projection unit 300 even if the flip-top is not at the exact angle (compared to the base unit 320) for which the keyboard-style pattern 325 was originally created.

In one embodiment of the present invention, shown in FIG. 4, the projection unit 300 virtually superimposes or integrates with the keyboard-style image 325 a mousepad 330 and corresponding mouse buttons 340. That is, a portion of the keyboard-style pattern 325 is virtually occluded and the mousepad 330 and buttons 340 are drawn where a portion of the keyboard-style pattern 325 image otherwise would have been drawn. (As would be understood by one of ordinary skill in the art, in embodiments utilizing a laser, the keyboard-style pattern 325 is not physically overwritten, but rather a portion of the keyboard-style pattern 325 is suppressed from being projected and the mousepad 330 and buttons 340 are projected in place of that portion of the keyboard-style pattern 325.)

Alternatively, the keyboard-style pattern 325 can be created using technology other than a projection unit 300. For example, a fixed pattern can be printed onto the base unit 320. In such a configuration, the user would not be able to see any changes to the interface as it was dynamically updated, but various keyboard configurations could nonetheless be used dynamically. In addition, the base unit 320 could be printed on with a variety of colors and patterns such that the user could, knowing the color corresponding to the current configuration, see several user interfaces simultaneously.

In yet another embodiment, the “overhead” projection unit of FIGS. 3 and 4 is replaced with a pattern generation device that is underneath the surface of where the user is interacting with the interface. For example, an LCD panel or display is typed on and tracked by the motion sensor 310. In this configuration, no special touch sensitive material is required for the LCD since the motion sensor can use infrared to pick up the hand motions. Similarly, even a monitor (including flat panel monitors) under glass or other transparent material can be used to generate the keyboard-style pattern 325. The user simply types on the transparent material, protecting the monitor from harm while dynamically being able to update the display. As would be understood by those of ordinary skill in the art, in light of the inexpensive nature of computer monitors, several monitors may be used together to increase the size of the keyboard-style pattern 325 that can be interacted with.

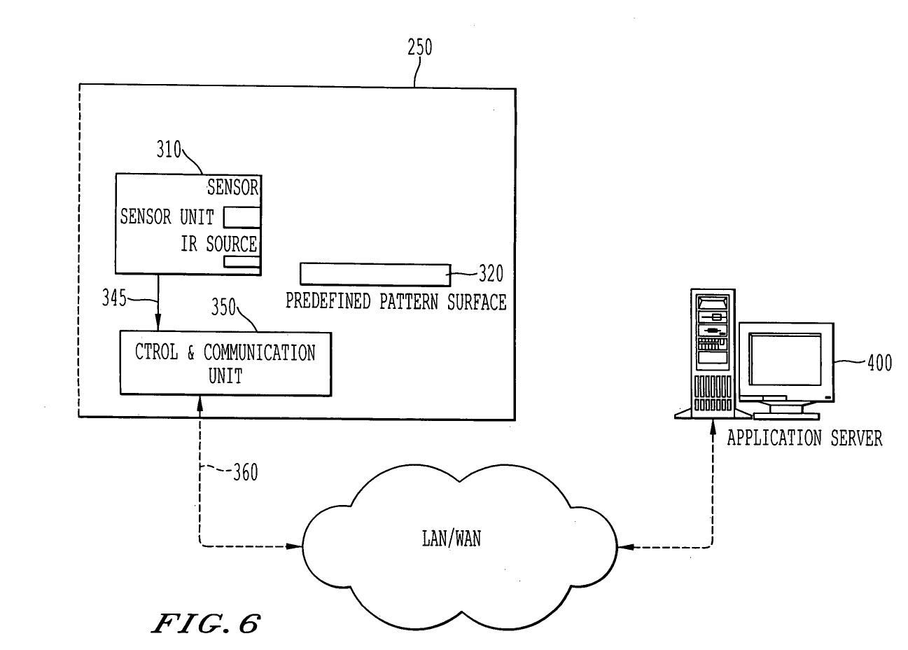

As illustrated in FIG. 5, the dynamic user interface may also be implemented in applications other than local computing environments (e.g., laptops and desktop computer environments). For example, a kiosk 250 may be equipped with a projection unit 300 that generates a user interface (e.g., a keyboard-style pattern 325 and/or a mousepad and corresponding buttons). Interactions with the keyboard-style pattern 325 are picked up by the motion sensor 310. Those interactions are communicated to a control and communications unit 350 over a communications link 345. The control and communications unit 350 may then either process those interactions locally or send them on to an application server 400 connected to the control and communications unit 350 by a LAN or WAN connection across at least one communications link 360. Such communications link may be any one or a combination of wired (e.g., Ethernet, ATM, FDDI, TokenRing) or wireless (e.g., 802.11a, b, g and other follow-on standards, and other RF and IR standards) links. Moreover, the communication protocols may include any one of connection-oriented and connectionless communications protocols using either datagram or error-correcting protocols. Such protocols include TCP/IP, UDP, etc.

Examples of applications for kiosks 250 include a public pay phone where the user interacts with the keyboard-style pattern 325 instead of a physical telephone interface. In light of the existence of a monitor and a keyboard-style pattern 325, a user of the kiosk 250 can also be provided with Internet related services or enhanced calling features as well. For example, a user may browse emails or facsimiles corresponding to the user. In a kiosk that implements a phone booth, the kiosk may also include a phone handset or a speakerphone that the user utilizes to communicate with a called party.

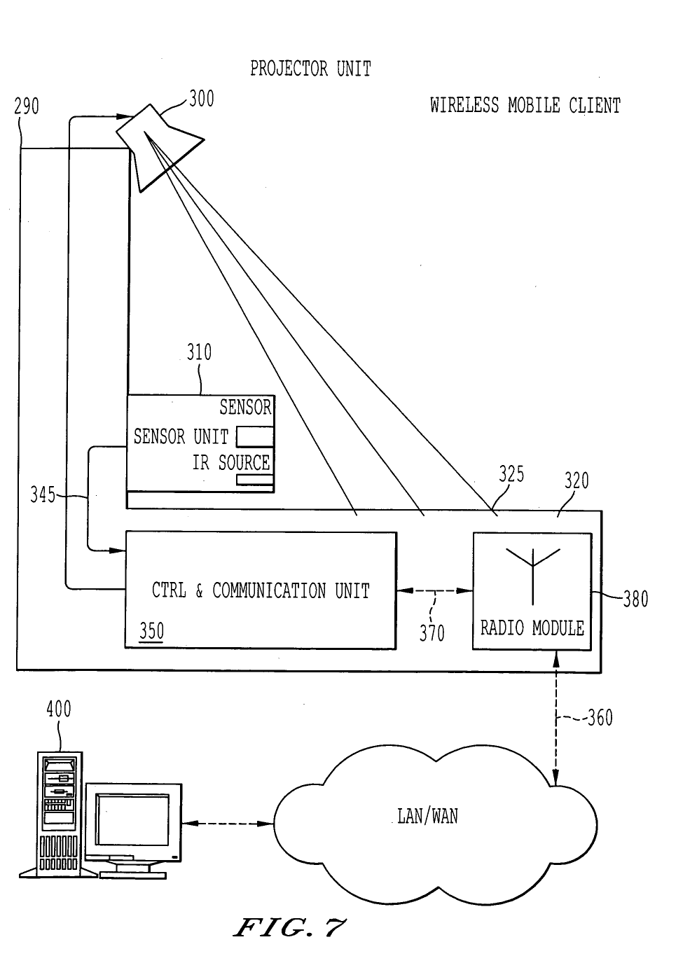

In an environment where a kiosk provider does not want to incur the cost or risk of providing a projection unit 300, either a user can bring his/her own projection unit (e.g., integrated within a PDA or other portable device) or the kiosk provider can provide a base unit 320 with a predefined pattern printed thereon (see FIG. 6). In an embodiment where the user brings his/her own projection unit, the projection unit 300 may include an interface for receiving any one or a combination of power and control signals used to drive the projection unit. Such interfaces can be any wired or wireless communication devices including, but not limited to Ethernet, serial, USB, parallel, Bluetooth, CDMA, GSM/GPRS, etc. Control signals sent to the projection unit may include which one of plural user interfaces (or partial user interfaces) is currently projected.

A provider of a kiosk 250 may also elect to utilize an under-mounted display technology, as described above with reference to a monitor or LCD panel covered with a transparent protective material.

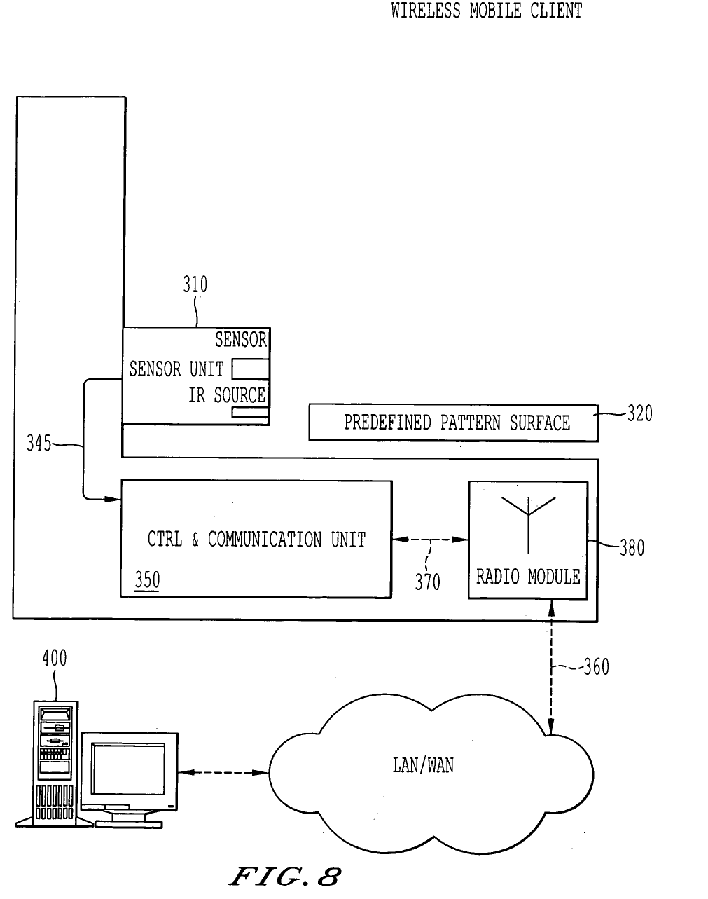

FIGS. 7 and 8 illustrate embodiments in which either the kiosk provider provides to a user or a user brings his own portable device 290 that interacts with a kiosk. The portable device 290 utilizes an RF module 380 (or an optical module such as an IR module) to communicate with an application server 400 across a WAN/LAN using at least one communications link 360. In this fashion, the entire control interface may be transported to and used in or near the kiosk.

Other possible kiosks or applications can include any interface description accessible by the user that may be transmitted from an application server 400 to a terminal containing the display mechanism, displayed on a surface, and operated upon by the user. Some applications include: web browsers; video conference applications (e.g., mute one or more participants, display a particular image to the audience, control volume, dial-in participants); multimedia equipment controls (e.g., wave your hand down to decrease volume-up to increase it; dial a station, play a CD); information kiosks; advertising displays with feedback mechanisms; ticketing services; self-service interfaces (e.g., vending machines); remote device control (e.g., cameras, alarms, locks); remote vehicle control to, for example, control vehicles in hazardous environments; industrial environments (flow controls, heating/ventilation/air conditioning); clean rooms; sterile and medical environments where mechanical equipment placement is prohibitive; test equipment; hazardous environments; remote control of distant objects; e.g., factory equipment, defense applications, building security (alarms, cameras, locking mechanisms); and simulations.

In order to dynamically generate the keyboard-style pattern 325 and/or determine a location on the keyboard-style pattern 325 that the user is interacting with, the present invention includes at least one of hardware and software for controlling at least one of the projection unit 300 and the motion sensor 310. In one software embodiment, a central processing unit (CPU) interacts with at least one memory (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The kiosk 250 may also include a floppy disk drive; other removable media devices (e.g., compact disc, tape, and removable magneto-optical media); and a hard disk, or other fixed, high density media drives, connected using an appropriate device bus (e.g., a SCSI bus, an Enhanced IDE bus, a Ultra DMA bus or a Serial ATA interface). The kiosk 250 may further include a compact disc reader, a compact disc reader/writer unit or a compact disc jukebox. In addition, a printer may also provides printed listings of work performed by a user at the kiosk 250.

As stated above, the software for controlling the kiosk (or the kiosk and the portable device) includes at least one computer readable medium. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the kiosk 250 and for enabling the kiosk 250 to interact with a human user. Such software may include, but is not limited to, device drivers, operating systems and user applications, such as development tools. Together, the computer readable media and the software thereon form a computer program product of the present invention for providing a virtual user interface. The computer code devices of the present invention can be any interpreted or executable code mechanism, including but not limited to scripts, interpreters, dynamic link libraries, Java classes, and complete executable programs. Such software controls a pattern to be displayed to a user, and the pattern may be dynamically changed in response to configuration information provided to the software. Such changes include changes in keyboard key labels and positions and shapes of individual keys. Such software further includes a dynamically configurable memory for determining which key corresponds to the portion of the keyboard interface that a user is interacting with. For example, if an existing key is split into two parts to make two keys in its place, a computer memory is updated to be able to differentiate interactions with one of the new keys from interactions with the other of the two keys. Similarly, if keys are added where no keys existed before, the software tracks the location and extent of the new key. Such tracking may also occur for a virtual mousepad and virtual mouse buttons.

In addition, any of the functions described above in terms of software can instead be implemented in special-purpose hardware such as FPGAs, ASIC, PALs, GALs, etc.

Numerous modifications of the above-teachings can be made by those of ordinary skill in the art without departing from the scope of protection afforded by the appended claims.

1. A dynamically configurable user-input interface for interacting with a user, comprising:
a projection unit for projecting (1) a first virtual interface including at least one of a virtual keyboard, a virtual mousepad and at least one virtual mouse button and (2) a second virtual interface including at least one of a virtual keyboard, a virtual mousepad and at least one virtual mouse button to be displayed in place of at least a portion of said first virtual interface;
a motion sensor for determining a position on the first and second virtual interfaces that is interacted with by a user;
a communications controller for communicating the position on the first and second virtual interfaces outside of the user-input interface; and
a controller for controlling the projection unit to switch from the first virtual interface to the second virtual interface.

2. The dynamically configurable user-input interface as claimed in claim 1, wherein the first virtual interface comprises a keyboard interface in a first language and the second virtual interface comprises a keyboard interface in a second language.

3. The dynamically configurable user-input interface as claimed in claim 1, wherein the first virtual interface comprises a keyboard interface and the second virtual interface comprises a mousepad.

4. The dynamically configurable user-input interface as claimed in claim 1, wherein the first virtual interface comprises a keyboard interface and the second virtual interface comprises a mousepad and at least one mouse button.

5. The dynamically configurable user-input interface as claimed in claim 1, further comprising a telephone interface for communicating by phone between the user and a remotely located telephone customer.
